(19) United States
(12) Patent Application Publication
(10) Pub. No.: US 2026/0042502 A1
(43) Pub. Date: Feb. 12, 2026

(54) PERSONAL TRANSPORT DEVICE WITH OPERATIONAL SEQUENCE INDICATION

(71) Applicant: Honda Motor Co., Ltd., Tokyo (JP)

(72) Inventors: Victor Eric ACUÑA, Torrance, CA (US); Dillon KANE, Torrance, CA (US); Geemay CHIA, Pasadena, CA (US); Ju Chia LEE, Pasadena, CA (US)

(21) Appl. No.: 18/797,790

(22) Filed: Aug. 8, 2024

(51) Int. Cl. B62J 6/22; B62K 15/00; H04M 1/72409

(52) U.S. Cl. CPC B62J 6/22; B62K 15/006; H04M 1/724098

(57) ABSTRACT

A compact personal transport vehicle is convertible between a use or riding configuration and a stowed configuration. An indication system is provided that indicates the sequence of the steps to be taken to transform the vehicle between the use configuration and the stowed configuration. The indication system may include a plurality of indicators corresponding to components of the vehicle to be moved to transform the vehicle, and a controller that activates the indicators in the sequence that the components are to be moved.

### BACKGROUND

This disclosure relates generally to vehicles, and more particularly to systems for indicating the sequence of steps to operate a personal transport vehicle to convert the vehicle between a riding configuration and a stowed configuration.

With rising prices of gasoline and automobiles, many people may turn to other more cost-efficient modes of transportation such as, for example, mopeds, bicycles, scooters and, more recently, compact personal transport devices, such as electric scooters. These personal transport devices may be particularly popular for shorter trips in a city environment due to their compact size, ease of use, mobility, and the fact that they may be folded as needed for ease of portability. They may also be useful for covering the first mile or last mile of a trip which is the link between a user's origin or destination and another transportation means, hub or mass transit network. One existing impediment to widespread use of compact personal transport devices is the difficulty in knowing how to set up and collapse the devices before and after their use.

Accordingly, there is a need in the art for an improved compact personal transport device that provides assistance so that it can be set up and collapsed easily.

### SUMMARY

In one aspect of the present disclosure, a vehicle operational sequence indication system includes a first member that is operable to move from a first configuration to a second configuration. A first indicator is provided corresponding to the first member. A second member is provided that is operable to move from a second member first configuration to a second member second configuration. A second indicator is provided corresponding to the second member. The first indicator is actuatable to indicate that the first member is to be moved from the first configuration to the second configuration, and the second indicator is actuatable sequentially after the first member is moved to the second configuration to indicate that the second member is to be moved from the second member first configuration to the second member second configuration.

In another aspect of the present disclosure, a vehicle operational sequence indication system includes a vehicle body, a first member operably connectable to the vehicle body, and a first indicator corresponding to the first member. The vehicle includes a second member operably connected to the vehicle body, and a second indicator corresponding to the second member. A controller is provided that activates the first indicator to indicate when the first member is to be operated and then sequentially activates the second indicator to indicate when the second member is to be operated.

In a further aspect of the present disclosure, a method for operating a vehicle includes actuating a first indicator corresponding to a first member that is operable to move from a first configuration to a second configuration. The method further includes moving the first member from the first configuration to the second configuration. The method also includes actuating a second indicator corresponding to a second member that is operable to move from a second member first configuration to a second member second configuration. The method then includes moving the second member from the second member first configuration to the second member second configuration.

Other systems, methods, features and advantages of the disclosure will be, or will become, apparent to one of ordinary skill in the art upon examination of the following figures and detailed description. It is intended that all such additional systems, methods, features and advantages be included within this description and this summary, be within the scope of the disclosure, and be protected by the following claims.

### BRIEF DESCRIPTION OF THE DRAWINGS

The disclosure may be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a perspective view of an example embodiment of a compact personal transport device in the form of an electric scooter vehicle in a riding configuration in accordance with aspects of the present disclosure;

FIG. 2 is an enlarged perspective view of a portion of the vehicle of FIG. 1 with the seat being removed in accordance with aspects of the present disclosure;

FIG. 3; is a side view of an interior of the vehicle of FIG. 1 in a partially stowed configuration in accordance with aspects of the present disclosure;

FIG. 4 is a perspective view of the vehicle of FIG. 1 with the seat in a stowed configuration in accordance with aspects of the present disclosure;

FIG. 5 is a perspective view of the vehicle of FIG. 1 with the seat and the steering assembly in a stowed configuration in accordance with aspects of the present disclosure;

FIG. 6 is a perspective view of the vehicle of FIG. 1 with the seat assembly, steering assembly, foot pegs and kick stand in a stowed configuration in accordance with aspects of the present disclosure;

FIG. 7 is a perspective view of the vehicle of FIG. 1 in a stowed configuration, including the seat assembly, steering assembly, foot pegs, kick stand and rear wheel all in a stowed configuration in accordance with aspects of the present disclosure;

FIG. 8 is a top view of a portion of the vehicle of FIG. 1 in a use configuration;

FIG. 9 is a display in the form of a phone for use in connection with the vehicle of FIG. 1 in accordance with one aspect of the present disclosure; and

FIG. 10 is a depiction of method steps useful with one embodiment of the present disclosure.

### DETAILED DESCRIPTION

Embodiments of a compact personal transport device or vehicle with a system for indicating the sequence of operating the device to facilitate converting the device between a use or riding configuration and a stowed configuration are described herein. In the riding configuration, the device may be used for “last-mile” or “first-mile” trips to and from a destination. In the stowed configuration, the personal transport device can be compact with a handle that allows a user to carry it in a primary vehicle, on public transportation, and/or on other forms of transportation to be used.

The example embodiments are described herein with reference to a vehicle or personal transport device in the form of an electric scooter. As used herein, an electric scooter is a term used mainly to describe a scooter that is electrically powered. For example, this is a type of personal transport device that is gaining ridership in many locations. The principles of the example embodiments described herein may be applied to vehicles such as electric scooters or other types of personal transport devices that may or may not be electrically powered, such as bicycles, unicycles, mopeds, skateboards, kickboards, wheelchairs, personal transporters, or the like.

In the example embodiments described herein, the electric scooter has a body or outer casing having a generally rectangular shape, including two flat sides having a length that is longer than a height. In addition, the electric scooter of the present embodiments has a width that is substantially smaller than the length and/or height of the electric scooter. In the example embodiments, the electric scooter may be transitioned between a use or riding configuration in which components of the electric scooter are in extended positions outside of the rectangular outer casing so that the electric scooter may be operated or ridden by a user to a stowed configuration in which components of the electric scooter are folded or stored inside the outer casing.

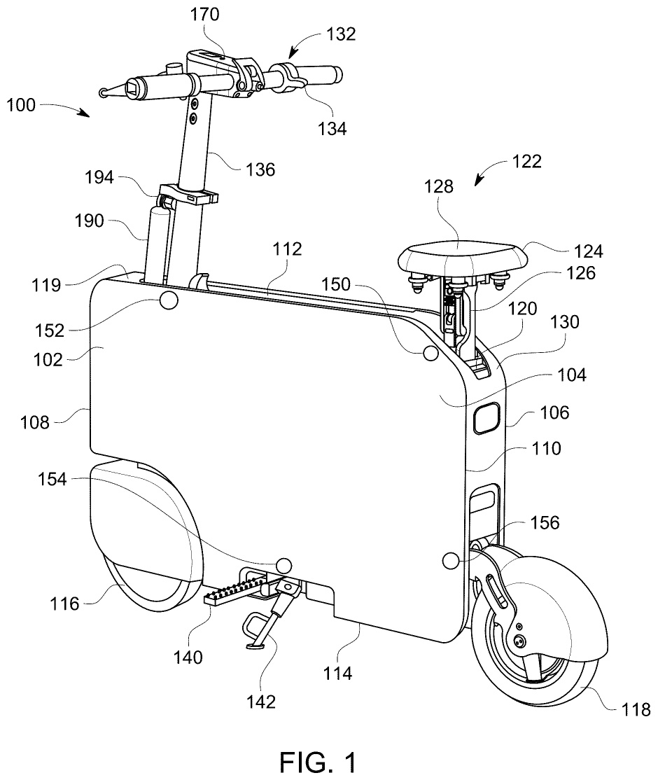

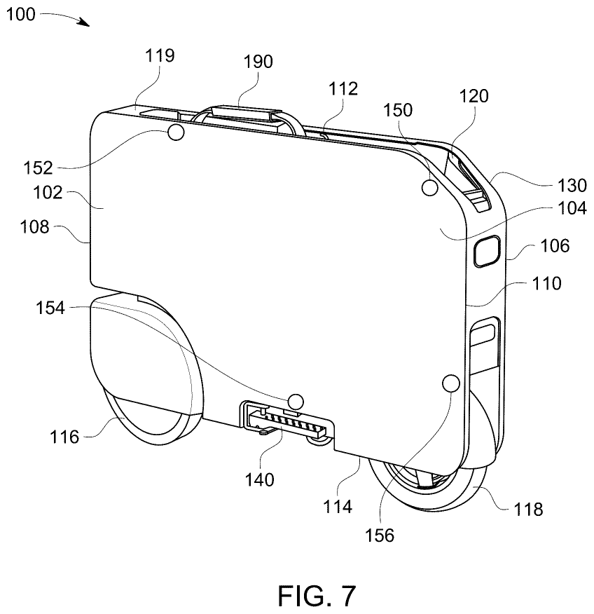

Referring now to FIG. 1, a perspective view of an example embodiment of a vehicle or personal transport device 100 (e.g., in the form of an electric scooter 100) is shown. In some embodiments, the vehicle 100 may be quickly transitioned or converted between a use or riding configuration in which components of the vehicle 100 are in extended positions outside of a body or outer casing 102 so that the vehicle 100 may be operated or ridden by a user to a stowed configuration in which components of the vehicle 100 are folded or collapsed to stored positions inside the outer casing 102. As shown in FIG. 1, the vehicle 100 is in the use or riding configuration (FIG. 7, described in detail below, shows the vehicle 100 in the stowed configuration). A system is disclosed herein that facilitates converting the vehicle 100 between the riding configuration and the stowed configuration.

In an example embodiment, the outer casing 102 of the vehicle 100 includes a first side surface 104 and an opposite second side surface 106. The outer casing 102 has a width between the first side surface 104 and the opposite second side surface 106 that defines a thickness of vehicle 100. In an example embodiment, side surfaces of outer casing 102 are substantially flat, including each of the first side surface 104 and the opposite second side surface 106. The outer casing 102 of the vehicle 100 extends between a front edge 108 and an opposite rear edge 110, as well as a top edge 112 and an opposite bottom edge 114. The front edge 108, rear edge 110, top edge 112, and bottom edge 114 are substantially straight and define an outer perimeter of the rectangular-shaped outer casing 102 of the vehicle 100.

In this embodiment, a front wheel 116 is visible along the bottom edge 114 of the vehicle 100 near the front edge 108. The vehicle 100 also includes a rear wheel 118 that is shown extended outside of the outer casing 102 (i.e., in the riding configuration as shown in FIG. 1) along the bottom edge 114 near the rear edge 110. The rear wheel 118 may be configured to slide and or retract inside of the outer casing 102 in the stowed configuration. One embodiment of the mechanism to allow the rear wheel 118 to be moved from a use configuration to a stowed configuration is disclosed in U.S. patent application Ser. No. 18/240,850, filed Aug. 31, 2023, entitled Rear Wheel Latching Mechanism, the contents of which application are incorporated herein by reference in their entirety.

The vehicle 100 includes a top surface 119 disposed between the first side surface 104 and the opposite second side surface 106. In an example embodiment, the top surface 119 includes an opening 120 extending substantially along the length of vehicle 100 (i.e., from the front edge 108 to the rear edge 110). In one embodiment, the opening 120 is disposed spaced from the front edge 108 of the vehicle 100 and extends all the way to the rear edge 110. In some embodiments, the opening 120 extends to the rear edge 110 along the top surface 119 partially extends down the rear edge 110. In this embodiment, the opening 120 is in the form of a slot disposed between the first side surface 104 and the opposite second side surface 106.

In embodiments of the present disclosure, the vehicle 100 includes components or members configured to allow a user to ride the vehicle 100 in the riding configuration. For example, in this embodiment, the vehicle 100 includes a first member or seat assembly 122, a second member or steering assembly 132, a third member or foot pegs 140 for supporting the feet of a rider, and a fourth member or rear wheel 118. The vehicle 100 may also include a kick stand 142 to hold the vehicle 100 upright when not in use. One embodiment of the foot peg 140 and the kick stand 142 mechanisms usable within the principles of the present disclosure is disclosed in U.S. patent application Ser. No. 18/240,871, filed Aug. 31, 2023, entitled Foot Peg And Kick Stand Unit For Convertible Compact Electric Transport Device, the contents of which application are incorporated herein by reference in their entirety. In the present embodiment, the components discussed above may be movable from a use configuration to a stowed configuration.

Some embodiments of the present disclosure require that movements of particular members to transform the vehicle 100 between the use and stowed configurations take place in a specific sequence. For example, in one embodiment, the seat assembly 122 is placed within the body 102 in the stowed configuration whereas when the steering assembly is in the stowed configuration, access to an interior of the body 102 may be blocked. Accordingly, the seat assembly 122 should be placed into the body 102 before the steering assembly 132 is moved to the stowed configuration. To facilitate operation of the vehicle 100 to convert the vehicle 100 between the use configuration and the stowed configuration in the proper sequence, the vehicle or personal transport device 100 may include a first indicator 150 corresponding to the first member or seat assembly 122. The first indicator 150 may be disposed on the body 102 proximate the seat assembly 122 at a position closer to the seat assembly 122 than the steering assembly 132, the foot pegs 140, or the rear wheel 118. In alternative embodiments, the first indicator 150 may be disposed on the seat assembly 122 or another portion of the vehicle 100.

Also, as shown in FIG. 1, a second indicator 152 corresponding to the steering assembly 132 may be provided at a location proximate to or on the steering assembly 132. For example, the second indicator 152 may be disposed on the body 102 adjacent to the steering assembly 132.

Likewise, a third indicator 154 corresponding to the foot pegs 140 and a fourth indicator 156 corresponding to the rear wheel 118 may be provided. It will be understood that the first indicator 150, second indicator 152, third indicator 154 and fourth indicator 156 may be similar in size, shape and construction, or in alternative embodiments, the indicators may be different from each other.

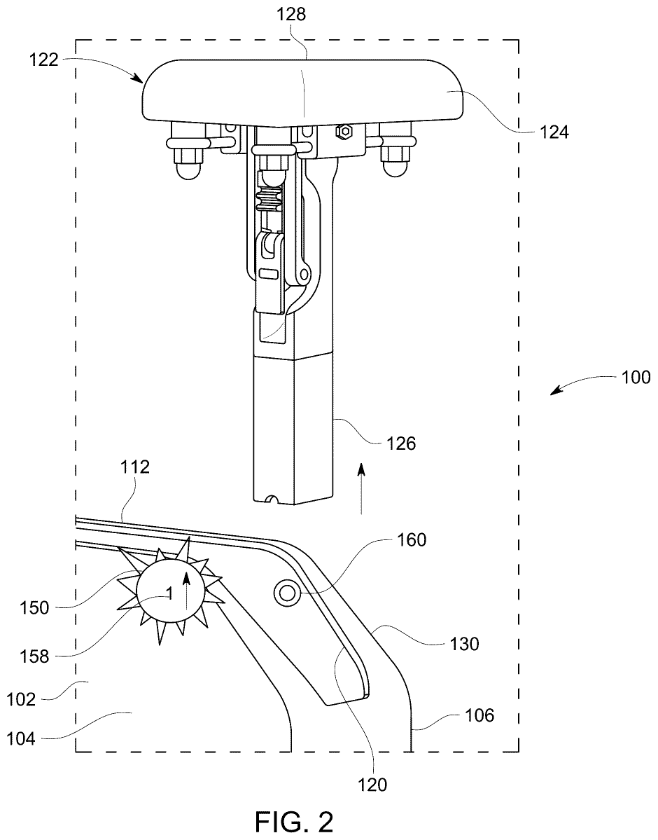

The first indicator 150 second indicator 152, third indicator 154 and fourth indicator 156 may be lights that are configured to flash as depicted by the first indicator 150 in FIG. 2, which depicts an enlarged perspective view of a portion of the vehicle 100 of FIG. 1 with the seat assembly 122 being removed in accordance with aspects of the present disclosure. The first indicator 150 may be configured to flash or light to provide instructions to the user of the vehicle 100 indicating the sequence of when the seat assembly 122 is to be moved when transforming the vehicle 100 from the use configuration to the stowed configuration or from the stowed configuration to the use configuration. The first indicator 150, as well as the other indicators, may also include indicia 158 in the form of numbers, depictions, symbols or writing that help provide information or instructions to an operator of the vehicle 100 indicating how to accomplish transformation of the vehicle 100 between a use and stowed configuration.

A sensor 160 may be provided to detect when the seat assembly 122 has been moved. The sensor 160 may be of a type known to those skilled in the art and may be positioned on the interior of the body 102 or on the seat assembly 122 or any other suitable location. Similarly, other such sensors may be provided at various different locations on the vehicle 100 to detect when other components, such as the steering assembly 132, foot pegs 140 and rear wheel 118 have been moved between the use configuration and the stowed configuration.

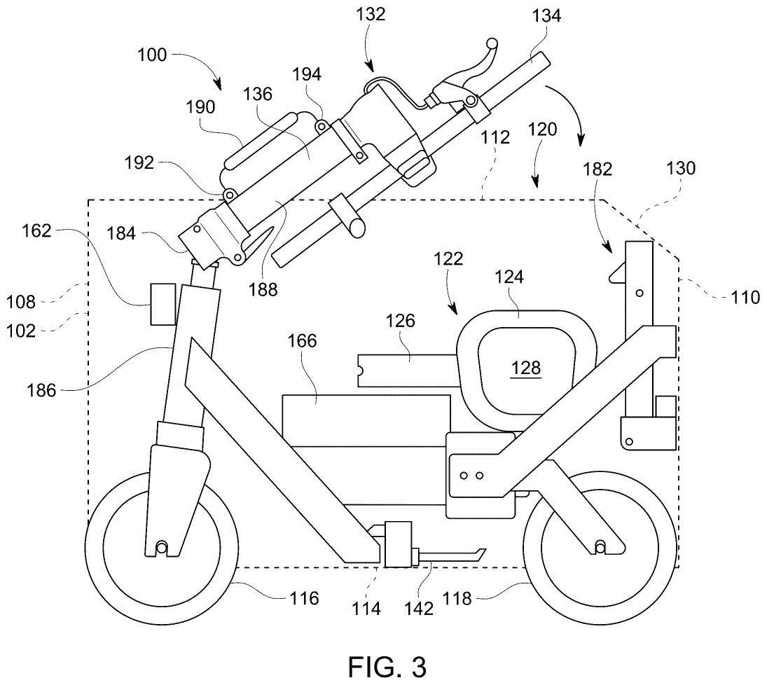

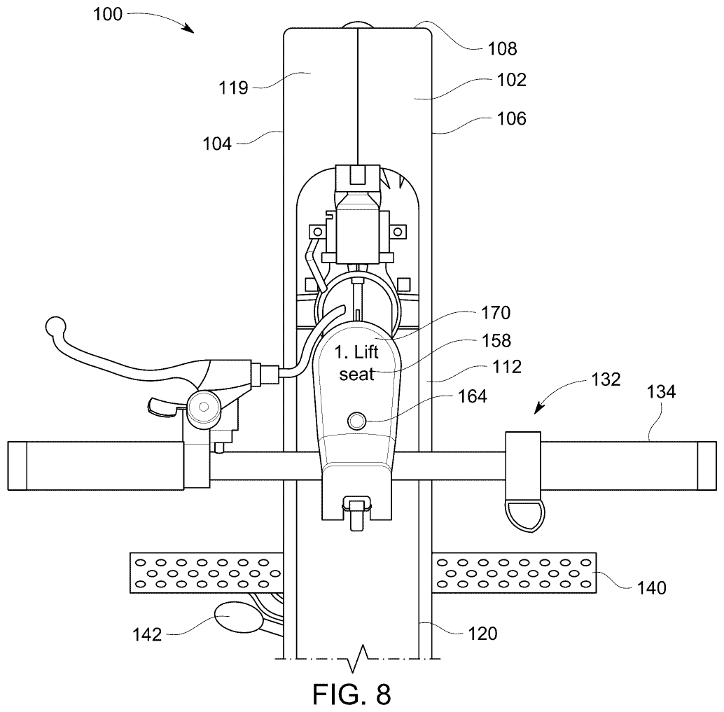

The first indicator 150, second indicator 152, third indicator 154 and fourth indicator 156 may be controlled by a controller 162 depicted schematically in FIG. 3, which depicts a side view of an interior of the vehicle 100 of FIG. 1 (the outer casing or body 102 is shown in dashed lines) in a partially stowed configuration in accordance with aspects of the present disclosure. The controller 162 may be connected to the indicators and sensors as well as other switches or buttons to activate the controller 162. For example, a button 164 (as shown in FIG. 8) may be provided on the steering assembly 132 to activate the controller 162 to provide instructions for transforming the vehicle 100 between the use and stowed configurations. Alternatively, the controller 162 may activate automatically when the vehicle 100 is turned on or off to provide signals to the indicators. The controller 162 may receive signals from components of the vehicle 100, such as the sensor 160 and may provide output to the appropriate indicators to flash or activate at the proper sequence for operating the corresponding member.

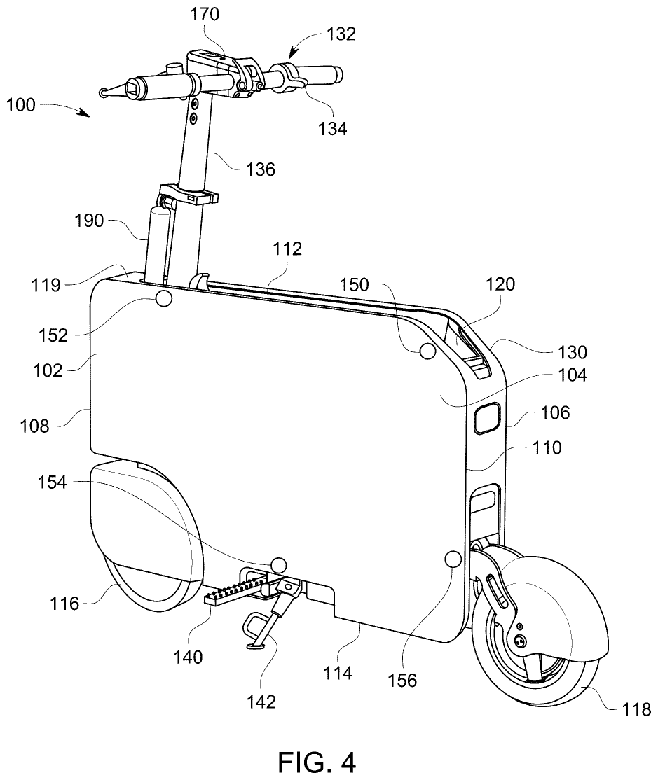

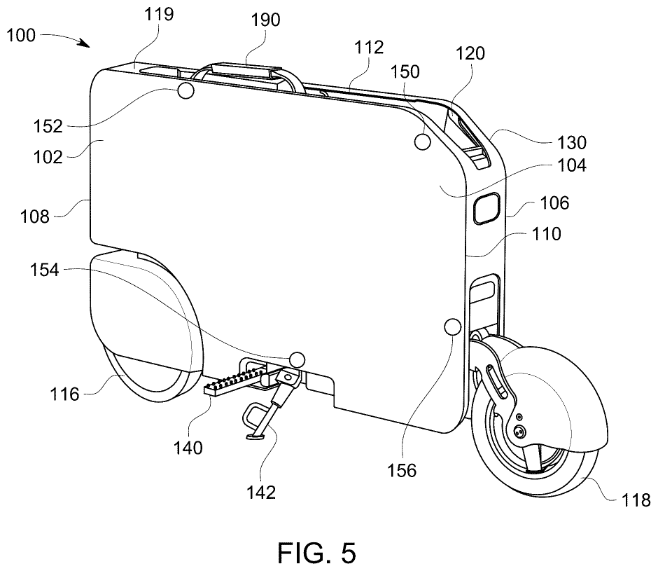

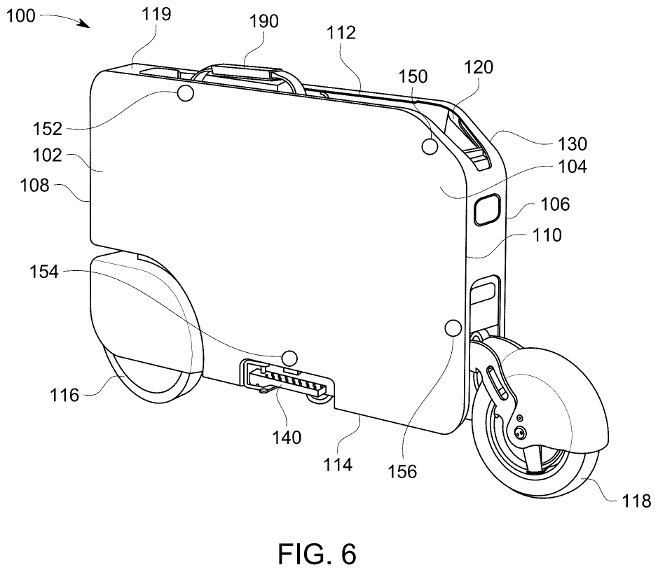

For example, in one embodiment of the present disclosure, when the vehicle 100 is in the use configuration and the rider desires to transform the vehicle 100 to the stowed configuration, the user may press the button 164. The controller 162 then sends a signal to the first indicator 150 to flash to indicate to the user to first stow the seat assembly 122. Once the seat assembly 122 has been moved to the stowed configuration as shown in FIG. 4, the sensor 160 sends a signal to the controller 162 and the controller 162 sends a signal to the second indicator 152. The second indicator 152 then flashes instructing the user to move the steering assembly 132 to the stowed configuration as shown in FIG. 5. The process can then continue so that the third indicator 154 is activated to instruct the user to move the foot pegs 140 to the stowed configuration as shown in FIG. 6. The fourth indicator 156 may then be activated to instruct the user to move the rear wheel 118 to the stowed configuration as shown in FIG. 7, so that all the components of the vehicle 100 have been moved to the stowed configuration.

FIG. 3 also discloses other features of the vehicle 100 on the inside of the body 102, including a battery 166 for providing power to the vehicle 100, the controller 162 and the indicators. Also depicted in FIG. 3 is the seat assembly 122 in the stowed configuration. As depicted the seat assembly 122 may be moved to be stowed inside the body 102. For this reason, the seat assembly 122 in this embodiment must be placed in the stowed configuration prior to placing the steering assembly in the stowed configuration to avoid blocking access to the interior of the body 102 for stowing the seat assembly 122.

It will be understood that some embodiments of the present disclosure may have more or fewer indicators and that the order of activation of the indicators may vary in accordance with the principles of the present disclosure. For example, in some embodiments, the steering assembly 132 may need to be folded before the seat assembly 122. Moreover, the order of operation of some of the features may not matter. In some embodiments, the foot pegs 140 or rear wheel 118 may be moved from the use configuration to the stowed configuration at any time and in any sequence, or they may also be moved from the stowed configuration to the use configuration in any sequence. In addition, folding of the steering assembly 132 or the seat assembly 122 may require multiple steps so that additional indicators may be provided corresponding to various individual steps of the folding and unfolding process of the steering assembly 132 and/or the seat assembly 122, and/or other members.

Additional details of one embodiment of the seat assembly 122 and steering assembly 132 will now be provided with reference to FIGS. 1-3. In one embodiment, the seat assembly 122 includes a seat 124 attached on top of a seat post 126 that is configured to mount to a corresponding frame post that is attached internally to the inside of the vehicle 100 (e.g., inside the outer casing 102). In an example embodiment, the seat assembly 122 is configured to be removably attached to the vehicle 100. The seat 124 includes a seat surface 128 having a substantially horizontal orientation that is perpendicular to the seat post 126 so that a user may comfortably sit on the seat 124 of the seat assembly 122 while riding the vehicle 100 in the riding configuration.

In an example embodiment, the seat assembly 122 is disposed at the rear of the vehicle 100 at or adjacent to the rear edge 110. In some embodiments, the outer perimeter of the rectangular-shaped outer casing 102 of the vehicle 100 may include a sloped edge 130 that extends between the top edge 112 and the rear edge 110 at a downwardly sloped angle. For example, in some cases, the angle of the sloped edge 130 may be in a range between 20 degrees and 45 degrees. The seat assembly 122 may be disposed directly above the sloped edge 130 and provides additional space or room underneath the seat assembly 122 compared to a squared edge at the intersection of the top edge 112 and the rear edge 110. By providing the sloped edge 130 under the seat assembly 122, a user of the vehicle 100 can easily access and manipulate a seat post release and handlebar holding mechanism associated with the seat assembly 122 to remove the seat assembly 122 from the vehicle 100. With this arrangement, the vehicle 100 may be quickly and conveniently transitioned between a riding configuration and a stowed configuration.

In some embodiments, the steering assembly 132 is configured to control orientation of the front wheel 116 to allow a user to steer the vehicle 100 in the riding configuration. In an example embodiment, the steering assembly 132 includes a handlebar 134 that is configured to receive hands of a user to steer the front wheel 116. In one embodiment as shown in FIG. 3, the steering assembly 132 includes a steering shaft 136 with a fork that is attached to an axle of the front wheel 116 at one end. The opposite end of the fork is attached to a lower portion 186 of the steering shaft 136 disposed inside of the outer casing 102 of the vehicle 100. The handlebar 134 is located at a top end of the steering shaft 136 and is connected to an upper portion 188 of the steering shaft 136. The upper portion 188 of the steering shaft 136 extends downwards towards the top edge 112 of the vehicle 100 and is extended outside of the outer casing 102 of the vehicle 100 through the opening 120 when the vehicle 100 is in the riding configuration (as shown in FIG. 1).

As shown in FIG. 1, the steering shaft 136 of the vehicle 100 extends upwards from the opening 120 when the vehicle 100 is in the riding configuration and is configured to be folded downwards into the opening 120 (as shown in FIG. 3) to transition the vehicle 100 to the stowed configuration, as will be described below. In this embodiment shown in FIG. 1, the handlebar 134 is shown in an extended position with a substantially horizontal orientation so that the handlebar 134 is approximately perpendicular to the steering shaft 136. The handlebar 134 and steering shaft 136 are configured to allow a user to control orientation of the front wheel 116 to steer the vehicle 100 in the riding configuration.

In an example embodiment, one or more portions of the steering shaft 136 may be telescopic. That is, one or more portions of the steering shaft 136 may be formed of concentric tubular sections designed to slide into one another to collapse or extend the steering shaft 136. For example, in one embodiment, the upper portion 188 of steering shaft 136 may be telescopic. With this arrangement, a height of the steering shaft 136 may be transitioned between a taller height in an extended position when the vehicle 100 is in the riding configuration and a shorter height in a folded position when the vehicle 100 is in the stowed configuration.

The lower portion 186 of the steering shaft 136 extends upwards from the fork inside of the outer casing 102 towards the top edge 112 of the vehicle 100 to a shaft connection mechanism 184 that includes a hinge (or similar mechanism) that connects the lower portion 186 and the upper portion 188 of the steering shaft 136. With this arrangement, the steering assembly 132 may be transitioned or converted from an upright extended position when the vehicle 100 is in the riding configuration (as shown in FIG. 1) through an intermediate position (as shown in FIG. 3) to a folded position when the vehicle 100 is in the stowed configuration (as shown in FIG. 7).

In some embodiments, a user may initiate the process of collapsing the steering assembly 132 of the vehicle 100 from the riding configuration to the stowed configuration by collapsing or sliding the telescoping segments of the upper portion 188 into each other to the move steering shaft 136 from its initial extended position to a shorter, collapsed position. Next, once the steering shaft 136 has been collapsed, the steering assembly 132 may be folded into the outer casing 102 of the vehicle 100 through the opening 120 at the top edge 112. As shown in FIG. 3, the steering assembly 132 is shown in an intermediate position in the process of being folded into the outer casing 102 of the vehicle 100 through the opening 120 as the vehicle 100 is being transitioned to the stowed configuration.

In an example embodiment, the shaft connection mechanism 184 may be unlocked to allow the steering shaft 136 to fold into the opening 120. The shaft connection mechanism 184 may include a hinge or similar mechanism that allows the upper portion 188 of the steering shaft 136 to fold from a generally vertical orientation outside of the outer casing 102 (e.g., when the vehicle 100 is in the riding configuration) to a generally horizontal orientation inside of the outer casing 102 (e.g., when the vehicle 100 is in the stowed configuration). In this embodiment, the lower portion 186 of the steering shaft 136 remains stationary. In an example embodiment, when the steering shaft 136 is folded at the shaft connection mechanism 184, the upper portion 188 of the steering shaft 136 and the handlebar 134 in the vertical orientation are folded into the outer casing 102 of the vehicle 100 through the opening 120 at the top edge 112. That is, the steering assembly 132 is fully folded into the outer casing 102 of the vehicle 100 in the stowed configuration.

In some embodiments, a carry handle 190 may be mounted on a portion of the steering shaft 136 so that the vehicle 100 in the stowed configuration may be easily carried or moved by a user. In one embodiment, the carry handle 190 has a generally C-shape with two opposite ends attached to the upper portion 188 of the steering shaft 136. As shown in FIG. 3, the upper portion 188 of the steering shaft 136 includes a first connection member 192 and a second connection member 194 that connect the carry handle 190 to the upper portion 188 of the steering shaft 136. In some cases, the carry handle 190 may be in the form of a strap that is attached to the upper portion 188 of the steering shaft 136 at the first connection member 192 at one end and at the second connection member 194 at the opposite end. In other embodiments, the carry handle 190 may have other configurations or shapes. With this arrangement, the carry handle 190 may be used to lift and/or carry the vehicle 100 when the vehicle 100 is in the stowed configuration.

Additionally, in some embodiments, the seat assembly 122 may be placed or stowed inside an internal storage compartment when the vehicle 100 in the stowed configuration. For example, as shown in FIG. 3, the seat assembly 122 is placed into an interior storage compartment of the vehicle 100 with the bottom end of the seat post 126 facing towards the front edge 108 of the vehicle 100 and the seat 124 facing towards the rear edge 110 of the vehicle 100. In other embodiments, the interior storage compartment of the vehicle 100 may have different arrangements to accommodate other orientations or placements of the seat assembly 122 within the interior of the vehicle 100.

Referring now to FIG. 7, the vehicle 100 is shown in its fully stowed configuration. In this embodiment, the steering assembly 132, including the handlebar 134 in the vertical orientation, is folded inside of the outer casing 102 of the vehicle 100 (e.g., within the interior storage compartment). When the vehicle 100 is collapsed from the riding configuration (as shown in FIG. 1) to the stowed configuration (as shown in FIG. 7), the vehicle 100 has a compact form that may be easily and conveniently carried by a user.

In an example embodiment, when the vehicle 100 is in the fully stowed configuration, as shown in FIG. 7, the carry handle 190 projects or extends upwards and above the opening 120 at the top edge 112 of the outer casing 102 of the vehicle 100. In some embodiments, a seat post release and holding mechanism 182 of the example embodiments may further assist with securing the steering assembly 132 and handlebar 134 in the folded position inside the outer casing 102 of the vehicle 100 so that when a user lifts the vehicle 100 by the carry handle 190, the steering assembly 132 and handlebar 134 remain in the folded position inside the outer casing 102 of the vehicle 100. That is, the release and holding mechanism 182 in the locked configuration prevents or stops the steering assembly 132 and handlebar 134 from being unfolded or removed from inside the outer casing 102 of the vehicle 100.

In some embodiments the first member or seat assembly 122 is operable to move from a first configuration or use configuration as shown in FIG. 1, to a second configuration or stowed configuration as shown in FIGS. 3-7. Similarly, the steering assembly 132 may form a second member that is operable to move from a second member first configuration or use configuration as showed in FIG. 1, to a second member second configuration or stowed configuration as shown in FIGS. 5-7. It will be understood that the configurations may be reversed in alternative arrangements or when the vehicle 100 is being converted from the stowed configuration to the use configuration. For example, the first configuration may be the stowed configuration and the second configuration may be the use configuration, and the second member first configuration may be the stowed configuration and the second member second configuration may be the use configuration in alternative arrangements.

Referring now to FIG. 8, a top view of a portion of the vehicle 100 is shown. The vehicle 100 may include a display 170 on the steering assembly 132. The display 170 may provide information for the rider, such as battery charge condition, speed of the vehicle, on/off condition, etc. In one embodiment, instructions may be provided by depictions, words, and/or sounds to inform the rider how to convert the vehicle 100 between the use and stowed configurations. Accordingly, in one embodiment, the first indicator 150, second indicator 152, third indicator 154, and fourth indicator 156, may be provided on the display 170.

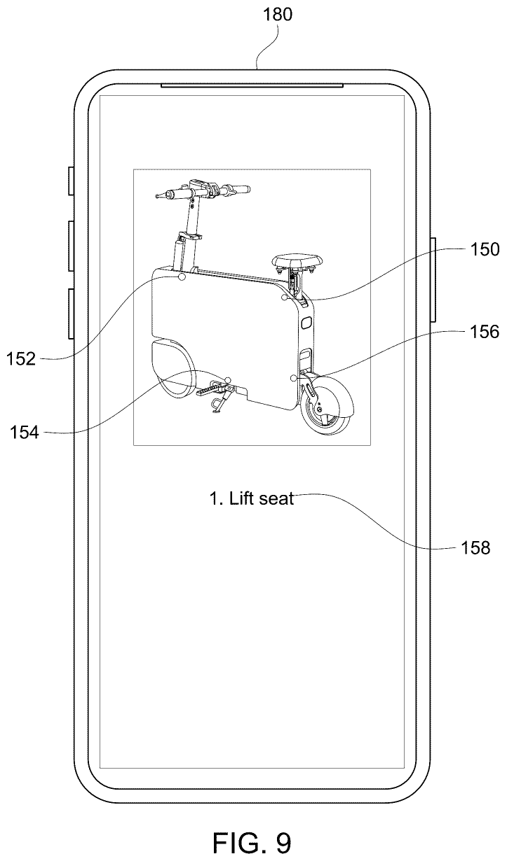

In addition or alternatively, instructions for converting the vehicle 100 between the use and stowed configurations may be provided on a software application for a phone 180, as depicted in FIG. 9. Accordingly, in one embodiment, the first indicator 150, second indicator 152, third indicator 154, and fourth indicator 156, may be provided on the phone 180. The phone 180 may be connectable to the personal transport device 100 such that data from the vehicle 100 may be displayed on the phone 180. For example, in addition to the folding and unfolding instructions, the state of charge of the battery 166 and other relevant information may be displayed.

It will also be understood that the principles of the present disclosure may be applied using virtual reality or augmented reality. For example, a software application or supporting software may be used in connection with augmented reality glasses to present digital content overlayed onto the vehicle 100 to cause virtual indicators to flash to demonstrate the order of movement of various members of the vehicle 100. Similarly, virtual reality headsets may be used to depict the vehicle 100 and sensors to instruct a user how to operate the vehicle 100. Accordingly, the first indicator 150, second indicator 152, third indicator 154, and fourth indicator 156, may be provided virtually in some embodiments.

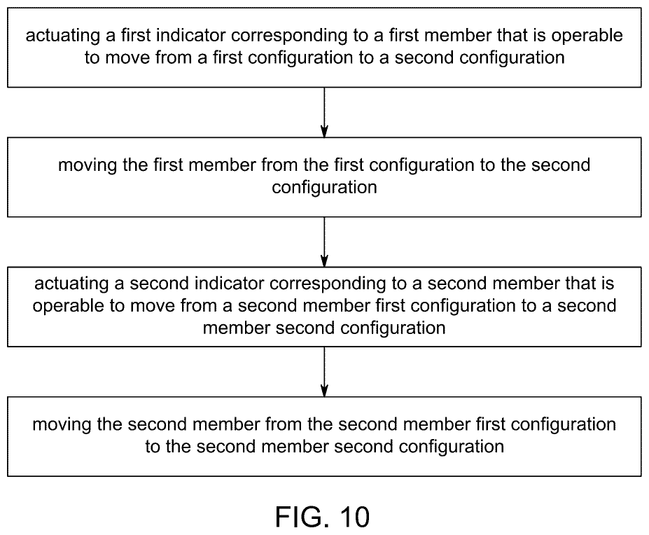

Referring now to FIG. 10, a depiction of method steps useful with one embodiment of the present disclosure is shown. In accordance with the embodiment of FIG. 10, steps of a method for operating a vehicle 100 may include:
actuating a first indicator corresponding to a first member that is operable to move from a first configuration to a second configuration;
moving the first member from the first configuration to the second configuration;
actuating a second indicator corresponding to a second member that is operable to move from a second member first configuration to a second member second configuration; and
moving the second member from the second member first configuration to the second member second configuration.

It will be understood that in some embodiments, not all the above steps may be required, and that additional steps may also be used in accordance with the principles of the present disclosure.

In some embodiments, the vehicle 100 may be transitioned back from the stowed configuration to the riding configuration by performing the various steps described herein in the reverse order to fully extend all of the components of the vehicle 100 outside of the outer casing 102 so that the vehicle 100 may be ridden by a user.

While various embodiments of the disclosure have been described, the description is intended to be exemplary, rather than limiting and it will be apparent to those of ordinary skill in the art that many more embodiments and implementations are possible that are within the scope of the disclosure. Accordingly, the disclosure is not to be restricted except in light of the attached claims and their equivalents. Also, various modifications and changes may be made within the scope of the attached claims.

1. A vehicle operational sequence indication system comprising:
a first member that is operable to move from a first configuration to a second configuration;
a first indicator corresponding to the first member;
a second member that is operable to move from a second member first configuration to a second member second configuration; and
a second indicator corresponding to the second member;
wherein the first indicator is actuatable to indicate that the first member is to be moved from the first configuration to the second configuration, and the second indicator is actuatable sequentially after the first member is moved to the second configuration to indicate that the second member is to be moved from the second member first configuration to the second member second configuration.

2. The vehicle operational sequence indication system of claim 1, further comprising:
a body, wherein the first member and the second member are operably connected to the body.

3. The vehicle operational sequence indication system of claim 2, wherein the first indicator is disposed on the body proximate the first member, and the second indicator is disposed on the body proximate the second member.

4. The vehicle operational sequence indication system of claim 2, wherein the first configuration is a use configuration of the first member, and the second configuration is a stowed configuration of the first member where the first member is stowed within the body, and the second member first configuration is a use configuration of the second member, and the second member second configuration is a stowed configuration of the second member where the second member is stowed within the body.

5. The vehicle operational sequence indication system of claim 1, wherein the first member is a vehicle seat assembly, and the second member is a vehicle steering assembly.

6. The vehicle operational sequence indication system of claim 1, wherein the first indicator and the second indicator are lights that are configured to flash when the first member and the second member are to be operated, respectively.

7. The vehicle operational sequence indication system of claim 1, further comprising a controller that sends a signal to actuate the first indicator and the second indicator.

8. The vehicle operational sequence indication system of claim 7, further comprising a sensor that detects when the first member is moved from the first configuration to the second configuration.

9. The vehicle operational sequence indication system of claim 1, further comprising:
a third member that is operable to move from a third member first configuration to a third member second configuration; and
a third indicator corresponding to the third member.

10. The vehicle operational sequence indication system of claim 9, further comprising:
a fourth member that is operable to move from a fourth member first configuration to a fourth member second configuration; and
a fourth indicator corresponding to the fourth member.

11. The vehicle operational sequence indication system of claim 1, further comprising:
a display for providing information regarding operation of the vehicle.

12. The vehicle operational sequence indication system of claim 11, wherein the display is disposed on at least one of the second member and a phone.

13. The vehicle operational sequence indication system of claim 3, wherein:
the first configuration is a use configuration of the first member, and the second configuration is a stowed configuration of the first member where the first member is stowed within the body, and the second member first configuration is a use configuration of the second member, and the second member second configuration is a stowed configuration of the second member where the second member is stowed within the body;
wherein the first member is a vehicle seat assembly, and the second member is a vehicle steering assembly;
wherein the vehicle operational sequence indication system further comprises:
a sensor that detects when the first member is moved from the first configuration to the second configuration;
a third member comprising a rear wheel that is operable to move from a use configuration of the third member to a stowed configuration of the third member where the third member is stowed within the body;
a third indicator corresponding to the third member;
wherein the first indicator, the second indicator and the third indicator are lights; and
a controller that send a signal to actuate the first indicator to cause the first indicator to flash when the first member is to be operated, the controller sends a signal to actuate the second indicator to cause the second indicator to flash when the second member is to be operated, and wherein the controller sends a signal to actuate the third indicator to cause the third indicator to flash with the third member is to be operated.

14. A vehicle operational sequence indication system comprising:
a vehicle body;
a first member operably connectable to the vehicle body;
a first indicator corresponding to the first member;
a second member operably connected to the vehicle body;
a second indicator corresponding to the second member; and
a controller that activates the first indicator to indicate when the first member is to be operated and then sequentially activates the second indicator to indicate when the second member is to be operated.

15. The vehicle operational sequence indication system of claim 14, wherein the first member is operable to move from a use configuration to a stowed configuration inside the body; and
the second member is operable to move from a second member use configuration to a second member stowed configuration inside the body.

16. The vehicle operational sequence indication system of claim 15, wherein the first member is a vehicle seat assembly and the second member is a vehicle steering assembly.

17. The vehicle operational sequence indication system of claim 14, wherein the first indicator and the second indicator are lights that are configured to flash when the first member and the second member are to be operated, respectively.

18. The vehicle operational sequence indication system of claim 15, further comprising:
a third member that is operable to move from a third member use configuration to a third member stowed configuration inside the body;
a third indicator corresponding to the third member;
a fourth member that is operable to move from a fourth member use configuration to a fourth member stowed configuration inside the body; and
a fourth indicator corresponding to the fourth member.

19. The vehicle operational sequence indication system of claim 14, further comprising:
a display for providing information regarding operation of the vehicle;
wherein the display is disposed on at least one of the second member and a phone.

20. A method for operating a vehicle, the method comprising:
actuating a first indicator corresponding to a first member that is operable to move from a first configuration to a second configuration;
moving the first member from the first configuration to the second configuration;
actuating a second indicator corresponding to a second member that is operable to move from a second member first configuration to a second member second configuration;
moving the second member from the second member first configuration to the second member second configuration.
